(19) United States
(12) Patent Application Publication
(10) Pub. No.: US 2009/0053531 A1
(43) Pub. Date: Feb. 26, 2009

(54) MULTI-LAYER CERAMIC SUBSTRATE WITH EMBEDDED CAVITY AND MANUFACTURING METHOD THEREOF

(76) Inventors: Chih Hung WEI, Taoyuan Hsien (TW); Yu Ping HSIEH, Taoyuan Hsien (TW)

Correspondence Address: BIRCH STEWART KOLASCH & BIRCH, PO BOX 747, FALLS CHURCH, VA, 22040-0747, US

(21) Appl. No.: 12/027,890

(22) Filed: Feb. 7, 2008

(30) Foreign Application Priority Data
Aug. 24, 2007 (TW) 096131432

(51) Int. Cl. B32B 17/06

(52) U.S. Cl. 428/426; 156/89.11

(57) ABSTRACT

A multi-layer ceramic substrate with an embedded cavity and a manufacturing method thereof are disclosed. The method includes the steps of: providing at least one ceramic thin plate and at least one ceramic pre-mold plate having a surface formed with a conductive layer; stacking the ceramic thin plate and the ceramic pre-mold plate to form a stacked structure with at least one embedded cavity; and sintering the stacked structure.

### CROSS REFERENCE TO RELATED APPLICATIONS

This Non-provisional application claims priority under 35 U.S.C. §119(a) on Patent Application No(s). 096131432 filed in Taiwan, Republic of China on Aug. 24, 2007, the entire contents of which are hereby incorporated by reference.

### BACKGROUND OF THE INVENTION

1. Field of Invention

The invention relates to a ceramic substrate and a manufacturing method thereof. More particularly, the invention relates to a multi-layer ceramic substrate with an embedded cavity and a manufacturing method thereof.

2. Related Art

At present, the electronic technology is rapidly developed, and the product is gradually miniaturized. Therefore, active and passive components are continuously developed in a direction toward the miniaturization. Due to the progress of the low-temperature co-fired ceramic technology (LTCC), the passive components can be integrated in a printing circuit ceramic substrate so that the area for the arrangement of the passive components and interconnections can be greatly reduced.

However, there are some problems to be solved in the LTCC application. The main drawback is the contraction caused by sintering the ceramic substrate, wherein the contraction in the plane direction has the greatest influence so that the circuits or the overall substrate may deform. In addition, the ceramic substrates produced in different batches may also have different contraction rations, thereby increasing the difficulty in the circuit design and the manufacturing processes and thus restricting the application range thereof. In order to decrease the contraction ration caused in the sintering process, the design and the manufacturing processes may be improved in the prior art. However, the manufacturing cost is increased, and the manufacturing processes become complicated.

The conventional ceramic substrate only has top and bottom surfaces, on which circuits may be formed or surface elements may be mounted, and thus cannot satisfy the miniaturized requirement.

Therefore, it is an important subject to provide a ceramic substrate, which has no sintering contraction in a plane direction and has surface elements integrated therein to increase the circuit integration, and a manufacturing method thereof.

### SUMMARY OF THE INVENTION

In view of the foregoing, the invention is to provide a multi-layer ceramic substrate with an embedded cavity, wherein the multi-layer ceramic substrate has no sintering contraction in a plane direction, and surface elements are integrated in the ceramic substrate to increase the circuit integration.

To achieve the above, the invention discloses a manufacturing method of a ceramic substrate with an embedded cavity. The method includes the steps of: providing at least one ceramic thin plate and at least one ceramic pre-mold plate having a surface formed with a conductive layer; stacking the ceramic thin plate and the ceramic pre-mold plate to form a stacked structure having at least one embedded cavity; and sintering the stacked structure.

In addition, the invention also discloses a multi-layer ceramic substrate with an embedded cavity including a plurality of dielectric layers and a plurality of conductive layers. The conductive layers and the dielectric layers are disposed separately, and the dielectric layer is formed with at least one embedded cavity.

As mentioned hereinabove, the multi-layer ceramic substrate with the embedded cavity and the manufacturing method thereof according to the invention have the following features. First, the sintered ceramic thin plate and the non-sintered ceramic pre-mold plate are stacked and sintered so that the ceramic thin plate can provide a constraining action to the ceramic pre-mold plate to suppress the ceramic pre-mold plate from contraction during the sintering process. Thus, the sintering contraction in the plane direction can be avoided. Compared with the prior art, the ceramic thin plate and the ceramic pre-mold plate have the same property, the contraction can be suppressed during the sintering process, and it is possible to prevent the ceramic thin plate and the ceramic pre-mold plate from being curved so that the even ceramic substrate can be obtained. In addition, the embedded cavity is formed inside the ceramic substrate and electronic elements are placed into the embedded cavity so that the circuit integration can be increased and the size of the substrate can be reduced.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more filly understood from the detailed description given herein below and accompanying drawings which are given by way of illustration only, and thus are not limitative of the present invention, and wherein:

FIG. 1 is a flow chart showing a manufacturing method of a ceramic substrate having an embedded cavity according to a preferred embodiment of the invention;

FIG. 2 is a schematic illustration showing a ceramic thin plate according to the embodiment of the invention;

FIG. 3 is a schematic illustration showing ceramic pre-mold plates and a stack thereof according to the embodiment of the invention; and

FIG. 4 is a schematic illustration showing the ceramic substrate having the embedded cavity according to the embodiment of the invention.

### DETAILED DESCRIPTION OF THE INVENTION

The present invention will be apparent from the following detailed description, which proceeds with reference to the accompanying drawings, wherein the same references relate to the same elements.

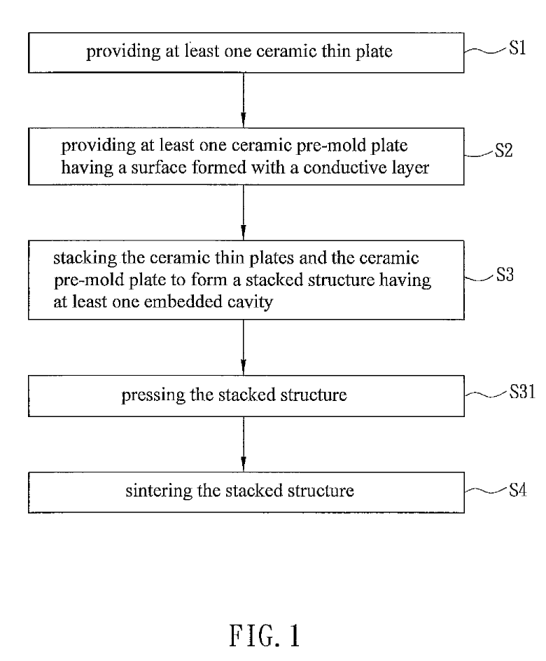

As shown in FIG. 1, a manufacturing method of a ceramic substrate according to a preferred embodiment of the invention includes steps S1 to S4.

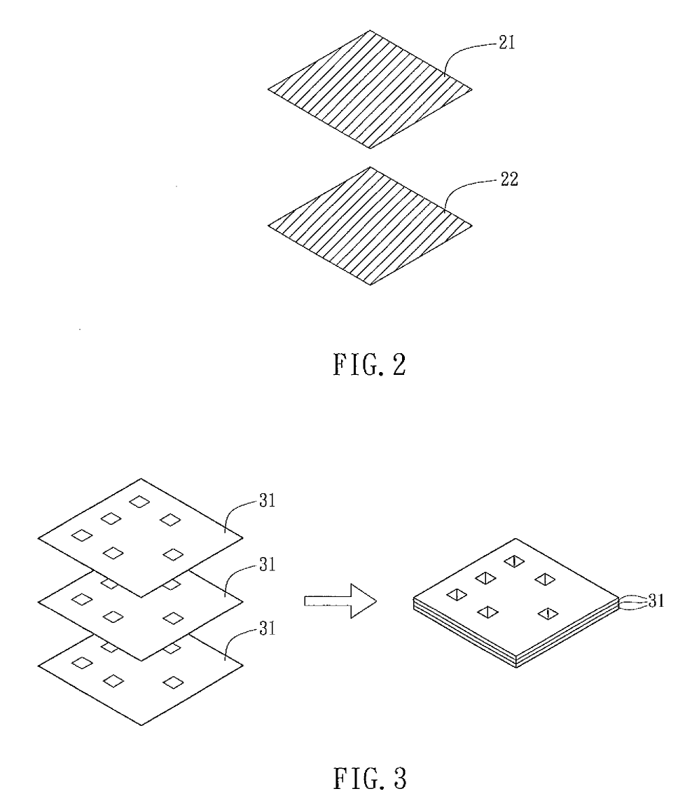

As shown in FIGS. 1 and 2, at least one ceramic thin plate is provided in the step S1. In this embodiment, two ceramic thin plates 21 and 22 are provided without any limitative purpose. The ceramic thin plates 21 and 22 may be prepared according to the following steps. First, a second pre-mold plate with a low sintering temperature interposed between two first pre-mold plates with high sintering temperatures. Next, the second pre-mold plate is sintered into the ceramic thin plates 21 and 22 at the low sintering temperature. During this sintering process, the first pre-mold plates provide a pressing action to the second pre-mold plate. Finally, the first pre-mold plates, which are not sintered, are removed from the second pre-mold plate so that each of the ceramic thin plate 21 and 22, which is not curved, is obtained.

As shown in FIGS. 1 and 3, at least one ceramic pre-mold plate 31 having a surface formed with a conductive layer (not shown) is provided in the step S2. The ceramic pre-mold plate 31 is composed of slurry formed by mixing at least one ceramic material and an inorganic adhesive or an organic carrier, wherein a polymeric adhesive, a plasticizer or an organic solvent may be added to form the slurry with the suitable viscosity. Then, a scraper is provided to form a thin plate. The surface of the ceramic pre-mold plate 31 can be formed with the conductive layer by way of printing.

The ceramic material can be selected from the group consisting of a ceramic powder, glass, a metal oxide powder, a composite metal oxide powder and a mixture thereof The selected inorganic adhesive does not have the chemical activity relative to the other materials, and has the physical properties that the sintering temperature thereof is lower than that of the ceramic material and that the inorganic adhesive being sintered is in a liquid phase. The inorganic adhesive may be a crystallized glass material, a crystallized glass ceramic material, a non-crystallized glass material or a non-crystallized glass ceramic material. The polymeric adhesive may be polyethylene glycol (PEG), polyvinyl butyral (PVB) or polyvinyl alcohol (PVA). The plasticizer can be dibutyl phthalate (DBP). The organic solvent can be n-propyl alcohol, toluene or alcohol.

The ceramic thin plates 21 and 22 or the ceramic pre-mold plate 31 provided in this embodiment of the invention may be formed with a hole in advance and a conductive material is filled into the hole or a conductive trace is printed on the hole. Alternatively, the ceramic pre-mold plate 31 can be a three-dimensional structure formed by stacking a plurality of pre-mold plates with cavities in advance.

As shown in FIGS. 1, 3 and 4, the ceramic thin plates 21 and 22 and the ceramic pre-mold plate 31 are stacked to form a stacked structure 32 in the step S3, wherein the stacked structure 32 has at least one embedded cavity 44. The ceramic thin plates 21 and 22 are disposed at a top portion and a bottom portion of the stacked structure 32, respectively. The stacked structure 32 has a plurality of vias electrically connected to at least two conductive layers. Each of the ceramic thin plates 21 and 22 is attached to the ceramic pre-mold plate 31 by adhering. The adhesive for adhering can be an inorganic adhesive, such as a glass material or a glass ceramic material, and the glass material can be the crystallized or non-crystallized material.

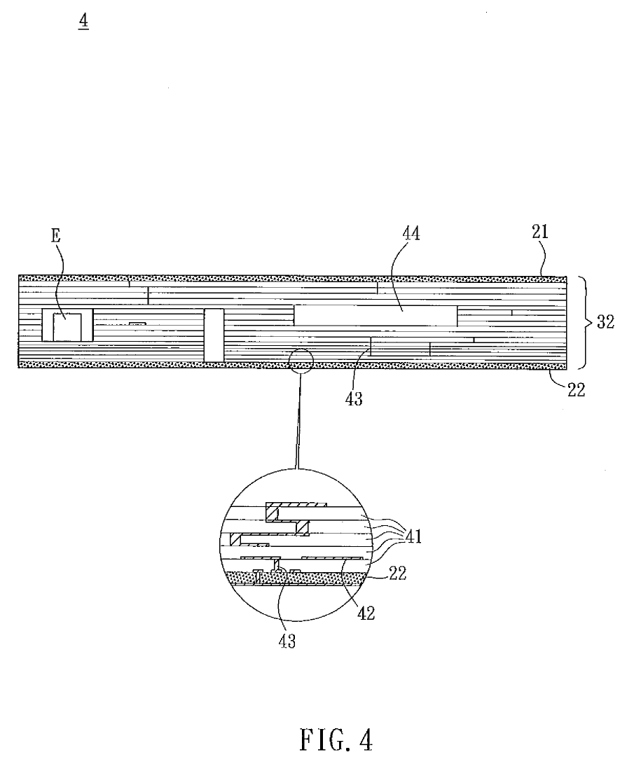

As shown in FIGS. 1 and 4, the stacked structure 32 is sintered to form a multi-layer ceramic substrate 4 in the step S4. The constraining forces produced by the ceramic thin plates 21 and 22 against the stacked structure 32 can be utilized so that the even multi-layer ceramic substrate 4, which has no sintering contraction and is not curved, can be manufactured.

After the step S3, the method of the invention may further include the step S31 of pressing the stacked structure 32 by way of hot pressing and isotatic pressing so that the stacked structure composed of the ceramic thin plates 21 and 22 and the ceramic pre-mold plate 31 becomes much denser. In addition, it is possible to prevent the multi-layer ceramic substrate 4 from being curved during the subsequent sintering process.

As shown in FIG. 4, the ceramic substrate 4 with an embedded cavity according to the preferred embodiment of the invention includes a plurality of dielectric layers 41, a plurality of conductive layers 42 and a plurality of vias 43. The conductive layers 42 and the dielectric layers 41 are disposed separately, and each via 43 is electrically connected to at least two conductive layers 42. The dielectric layer 41 is formed with at least one embedded cavity 44, and an electronic element E, which is disposed on a surface of a conventional ceramic substrate, is placed into the embedded cavity 44 so that the circuit layout on the surface of the multi-layer ceramic substrate 4 becomes more flexible, and the circuit integration can be increased or the size of the substrate can be reduced. The ceramic substrate 4 is a low-temperature co-fired ceramic (LTCC) substrate and may be applied to an IC carrier with high precision, a multi-chip module or a weather-resistant circuit board. The electronic element E can be an active/passive component or a passive component, such as a capacitor, an inductor, a resistor or a passive component with surface mount resistor.

In summary, the multi-layer ceramic substrate with the embedded cavity and the manufacturing method thereof according to the invention have the following features. First, the sintered ceramic thin plate and the non-sintered ceramic pre-mold plate are stacked and sintered so that the ceramic thin plate can provide a constraining action to the ceramic pre-mold plate to suppress the ceramic pre-mold plate from contraction during the sintering process. Thus, the sintering contraction in the plane direction can be avoided. Compared with the prior art, the ceramic thin plate and the ceramic pre-mold plate have the same property, the contraction can be suppressed during the sintering process, and it is possible to prevent the ceramic thin plate and the ceramic pre-mold plate from being curved so that the even ceramic substrate can be obtained. In addition, the embedded cavity is formed inside the ceramic substrate and the electronic elements are placed into the embedded cavity so that the circuit integration can be increased and the size of the substrate can be reduced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A manufacturing method of a ceramic substrate, comprising steps of:
providing at least one ceramic thin plate and at least one ceramic pre-mold plate;
stacking the ceramic thin plate and the ceramic pre-mold plate to form a stacked structure; and
sintering the stacked structure.

2. The method according to claim 1, further comprising a step of pressing the stacked structure, before the step of sintering the stacked structure, by hot pressing and isotatic pressing.

3. The method according to claim 1, wherein the ceramic pre-mold plate has at least one conductive layer, and the stacked structure has a plurality of vias electrically connected to the conductive layer.

4. The method according to claim 1, wherein the ceramic thin plate comprises at least two first pre-mold plates with high sintering temperatures and a second pre-mold plate with a low sintering temperature disposed between the two first pre-mold plates, the second pre-mold plate is sintered into the ceramic thin plate at the low sintering temperature, and the first pre-mold plates are removed after the second pre-mold plate is sintered into the ceramic thin plate.

5. The method according to claim 1, wherein the ceramic pre-mold plate is composed of slurry comprising at least one ceramic material and an inorganic adhesive or an organic carrier.

6. The method according to claim 5, wherein the ceramic material comprises a ceramic powder, glass, metal oxide, composite metal oxide or a mixture thereof.

7. The method according to claim 1, wherein the ceramic pre-mold plate further comprises a polymeric adhesive, a plasticizer or an organic solvent, wherein the polymeric adhesive is polyethylene glycol, polyvinyl butyral (PVB) or polyvinyl alcohol.

8. The method according to claim 1, wherein the ceramic thin plate is attached to the ceramic pre-mold plate by an inorganic adhesive, a crystallized glass material, a crystallized glass ceramic material, a non-crystallized glass material or a non-crystallized glass ceramic material.

9. The method according to claim 1, wherein the ceramic thin plate or the ceramic pre-mold plate is formed with a hole in advance, and a conductive material is filled into the hole, or a conductive trace is printed on the hole.

10. The method according to claim 1, wherein the ceramic pre-mold plate is a three-dimensional structure formed by stacking a plurality of pre-mold plates with cavities in advance.

11. The method according to claim 1, wherein the ceramic thin plate comprises a first ceramic thin plate and a second ceramic thin plate disposed at a top portion and a bottom portion of the stacked structure, respectively.

12. A ceramic substrate formed by stacking and sintering at least one ceramic thin plate and at least one ceramic pre-mold plate.

13. The ceramic substrate according to claim 12, wherein the ceramic pre-mold plate is composed of slurry comprising at least one ceramic material and an inorganic adhesive or an organic carrier.

14. The ceramic substrate according to claim 13, wherein the ceramic material comprises a ceramic powder, glass, metal oxide, composite metal oxide or a mixture thereof, and the ceramic pre-mold plate comprises a polymeric adhesive, a plasticizer or an organic solvent.

15. The ceramic substrate according to claim 13, wherein the ceramic thin plate is attached to the ceramic pre-mold plate by an inorganic adhesive, a crystallized glass material, a crystallized glass ceramic material, a non-crystallized glass material or a non-crystallized glass ceramic material.

16. The ceramic substrate according to claim 13, wherein the ceramic thin plate or the ceramic pre-mold plate has a cavity, a conductive material or a conductive trace.

17. The ceramic substrate according to claim 13, wherein the ceramic pre-mold plate is a three-dimensional structure formed by stacking a plurality of pre-mold plates with cavities.

18. The ceramic substrate according to claim 13 further comprising at least one embedded cavity, wherein the one electronic element is placed into the embedded cavity.

19. The ceramic substrate according to claim 18, wherein the electronic element is an active/passive component, a passive component, a capacitor, an inductor, a resistor or a passive component with surface mount resistor.

20. The ceramic substrate according to claim 13, wherein the ceramic thin plate comprises a first ceramic thin plate and a second ceramic thin plate respectively disposed at a top portion and a bottom portion of the ceramic substrate.

21. The ceramic substrate according to claim 13, wherein the ceramic substrate is a low-temperature co-fired ceramic (LTCC) substrate.

22. The ceramic substrate according to claim 13, wherein the ceramic substrate comprises a plurality of conductive layers and a plurality of vias electrically connected to the conductive layers.
